(19) United States
(12) Patent Application Publication
(10) Pub. No.: US 2013/0192031 A1
(43) Pub. Date: Aug. 1, 2013

(54) SYSTEM FOR PERSONALIZING ITEMS

(71) Applicants: Raul Molina, Homestead, FL (US); Karen Marquez-Molina, Homestead, FL (US)

(72) Inventors: Raul Molina, Homestead, FL (US); Karen Marquez-Molina, Homestead, FL (US)

(21) Appl. No.: 13/359,646

(22) Filed: Jan. 27, 2012

(51) Int. Cl. A44B 18/00; B23P 17/00; G09F 3/00; A44B 99/00; F16G 11/00

(52) U.S. Cl. 24/306; 24/570; 24/129 C; 40/299.01; 29/592

(57) ABSTRACT

One example embodiment includes a system for personalizing items. The system includes a body. The system also includes a hole, wherein the hole passes completely through at least a portion of the body.

### CROSS-REFERENCE TO RELATED APPLICATIONS

This application claims the benefit under 35 USC 119(e) of and priority to the provisional Application resulting from the conversion of U.S. Provisional patent application Ser. No. 13/020,019 filed on Feb. 3, 2011, which application is incorporated herein by reference in its entirety.

### BACKGROUND OF THE INVENTION

Items owned by different people can frequently be confused with one another. In particular, items rarely offer customizations in design. Even when customizations are offered, they normally include only a few varieties. That is, the buyer may be able to select from among a few options, so there are many other consumers who can potentially own an identical item. This means that there is a high likelihood of confusing similar items.

Consumers often try to customize items in their own way in order to differentiate them. For example, consumers may engrave the items (carve a name or word on the item), paint distinctive words or pictures on the item, place the item in a cover or carrying case or otherwise make the appearance of the item distinctive. However, there are a number of drawbacks to these approaches.

For example, consumers may have chosen the item for aesthetic reasons. That is, the consumer may have chosen the item because of the way that it looks. Any attempt, therefore, to change the look of the item may destroy the aesthetic reasons that the consumer chose the item for. Therefore, the consumer may be reluctant to modify or cover up the item.

In addition, these methods may damage the item. For example, engraving the item may break through the outer case of the item or may otherwise damage external portions of the item. Therefore, the consumer may be reluctant to customize the product in such a way that the functionality of the item may be lost.

Accordingly, there is a need in the art for a system for personalizing items that is highly customizable. Additionally, there is a need for the system to preserve the aesthetics of the item. Further, there is a need in the art for the system to preserve the functionality of the item.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for personalizing items. The system includes a body. The system also includes a hole, wherein the hole passes completely through at least a portion of the body.

Another example embodiment includes a system for personalizing items. The system includes a body. The system also includes a hole, wherein the hole passes completely through at least a portion of the body. The system further includes a slit, wherein the slit is configured to allow at least a portion of an external device to be inserted into the hole.

Another example embodiment includes a method of manufacturing a system for personalizing items. The method includes providing a body. The method also includes providing a hole, wherein the hole passes completely through at least a portion of the body. The method further includes providing a slit, wherein the slit is configured to allow at least a portion of an external device to be inserted into the hole.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of the example of a system for personalizing items;

FIG. 1B illustrates a front view of the example of a system for personalizing items;

FIGS. 1C illustrates a rear view of the example of a system for personalizing items;

FIG. 2A illustrates a front view of the system in use;

FIG. 2B illustrates a rear view of the system in use; and

FIG. 3 is a flow chart illustrating a method of manufacturing a system.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

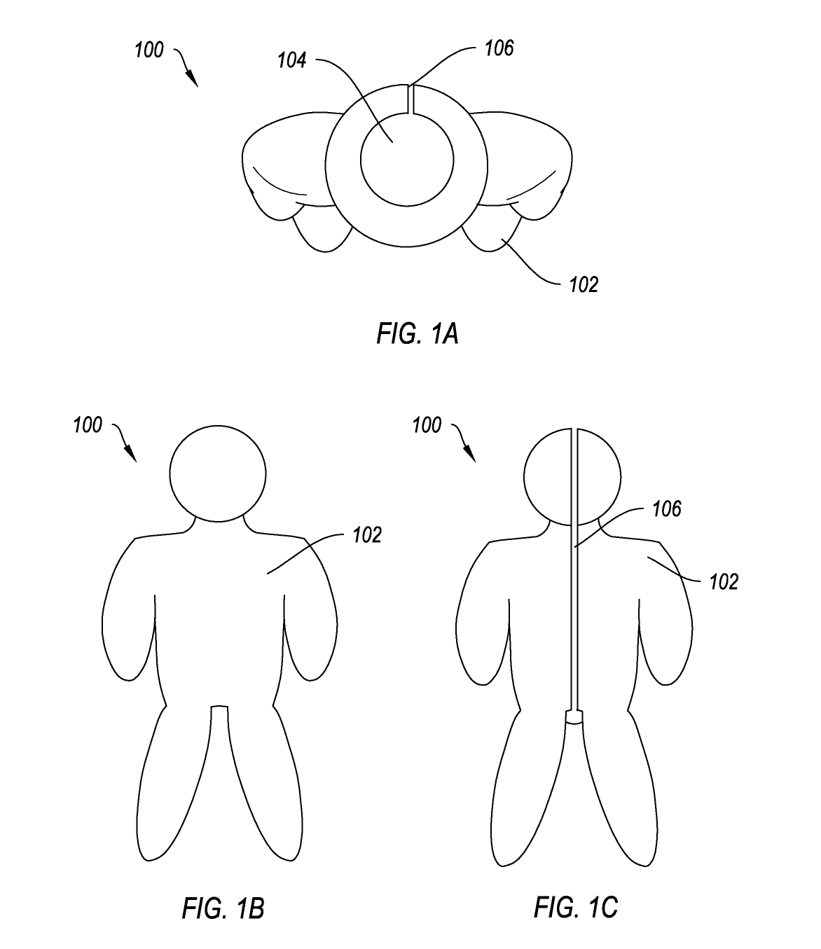

FIGS. 1A, 1B and 1C illustrate an example of a system 100 for personalizing items. FIG. 1A illustrates a top view of the example of a system 100 for personalizing items; FIG. 1B illustrates a front view of the example of a system 100 for personalizing items; and FIGS. 1C illustrates a rear view of the example of a system 100 for personalizing items. In at least one implementation, the system 100 can be attached to an external device, as described below. For example, personalizing the external device can include decorating the item or giving the item a distinctive look, allowing a user to easily identify the external device.

FIG. 1 shows that the system 100 can include a body 102. In at least one implementation, the body 102 can include a decorative design. In particular, the body 102 can be formed into any desired size, shape or color. For example, the body 102 can include a figure, a symbol, writing, an animal or any other desired shape. The body 102 can include custom size, shapes and colors to allow the user to identify his/her possessions easily. For example, the body 102 can include specialized or custom sizes, shapes or colors designed by the user.

In at least one implementation, the body 102 can be constructed of any desired material. For example, the body 102 can be constructed of silicone, pvc, rubber, plastic, wood, metal or any other desired material. For example, the material can include precious metals such as gold, platinum and silver. The material can be selected based on the look of the material, the feel of the material or any other desired criteria. The material can be pre-selected or presented to the user who can select from available materials.

In at least one implementation, the body 102 can include coloring or other decorations. For example, the user can select from different body 102 colors or can be allowed to customize the color of the body 102. E.g., the user may be able to select portions of the body 102 to be a particular color, with other portions of the body 102 other colors. Additionally or alternatively, the body 102 can be decorated with gems, beads, jewels, crystals, stones or other decorative inserts.

FIG. 1 also shows that the system 100 can include a hole 104. In at least one implementation, the hole 104 can be used to attach the system 100 to a desired external device or object. For example, a wire or cable on an electronic or other device can be passed through the hole 104. Additionally or alternatively, an attachment mechanism can be passed through the hole 104 and attached to the desired external device or object. For example, the attachment mechanism can include a string, a hook and loop fastener or any other desired attachment mechanism.

FIG. 1 further shows that the system 100 can include a slit 106. In at least one implementation, the slit 106 can allow the desired external device, or a portion thereof, to be inserted into the hole 104. I.e., the slit 106 can allow the body 102 to be manipulated such that access to the hole 104 is allowed. The slit 106 can allow a solid external device to be placed within the hole 104. I.e., the slit 106 can allow even external devices, where access is prevented on the ends, such as wires or other attached portions, to be inserted into the hole 104.

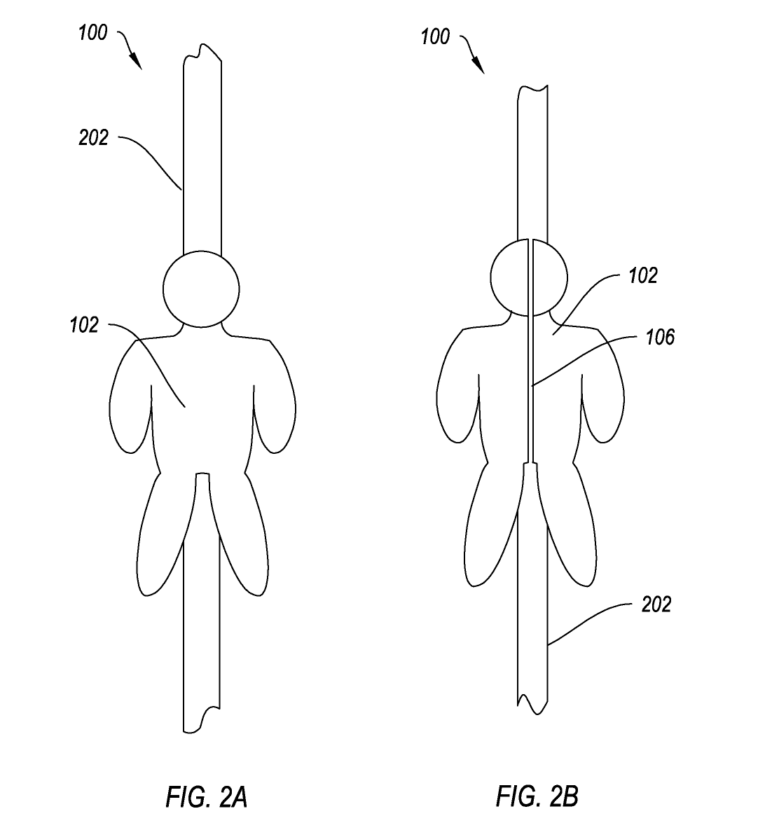

FIGS. 2A and 2B illustrate an example of the system 100 in use. FIG. 2A illustrates a front view of the system 100 in use; and FIG. 2B illustrates a rear view of the system 100 in use. In at least one implementation, the system 100 can be used to identify desired objects. For example, the system 100 can be used to personalize or accessorize the desired objects. In particular, the system 100 is capable of being attached to the desired object, making visual identification of the object, and, therefore, evidence of its ownership or origin easily identifiable.

FIGS. 2A and 2B show that the system 100 can be attached to an external device 202. In at least one implementation, the external device 202 can include any desired object. For example, the external device 202 can include a wire or other attachment device to which the system 200 is attached. E.g., the external device 202 can include a wire, string, cable, or other object, which is passed through the slit 106 into the hole of the body 102.

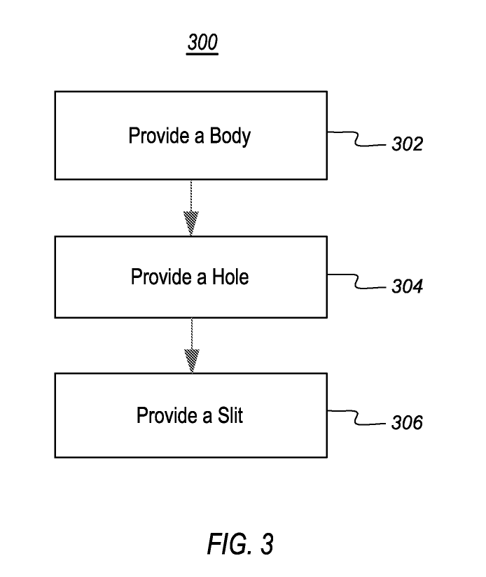

FIG. 3 is a flow chart illustrating a method 300 of manufacturing a system. In at least one implementation, the system can include a system for personalizing items, such as the system 100 of FIGS. 1A, 1B, 1C, 2A and 2B. Therefore, the method 300 will be described, exemplarily, with reference to the system 100 for personalizing items of FIG. 1A, 1B, 1C, 2A and 2B. Nevertheless, one of skill in the art can appreciate that the method 300 can be used to produce a system other the system 100 for personalizing items of FIG. 1A, 1B, 1C, 2A and 2B.

FIG. 3 shows that the method 300 can include providing 302 a body. In at least one implementation, the body can include a decorative design. In particular, the body can be formed into any desired size, shape or color. For example, the body can include a figure, a shape, a symbol, writing, an animal or any other desired shape. The body can include custom size, shapes and colors to allow the user to identify his/her possessions easily. For example, the body can include specialized or custom sizes, shapes or colors designed by the user.

In at least one implementation, the body can be constructed of any desired material. For example, the body can be constructed of silicon, pvc, rubber, plastic, wood, metal or any other desired material. For example, the material can include precious metals such as gold, platinum and silver. The material can be selected based on the look of the material, the feel of the material or any other desired criteria. The material can be pre-selected or presented to the user who can select from available materials.

In at least one implementation, the body can include coloring or other decorations. For example, the user can select from different body colors or can be allowed to customize the color of the body. E.g., the user may be able to select portions of the body to be a particular color, with other portions of the body other colors. Additionally or alternatively, the body can be decorated with gems, beads, jewels, crystals, stones or other decorative inserts.

FIG. 3 also shows that the method 300 can include providing 304 a hole. In at least one implementation, the hole can be used to attach the method 300 to a desired external device. For example, a wire on an electronic device can be passed through the hole. Additionally or alternatively, an attachment mechanism can be passed through the hole and attached to the desired external device. For example, the attachment mechanism can include a string, a hook and loop fastener or any other desired attachment mechanism.

FIG. 3 further shows that the method 300 can include providing 306 a slit. In at least one implementation, the slit can allow the desired external device, or a portion thereof, to be inserted into the hole. I.e., the slit can allow the body to be manipulated such that access to the hole is allowed. The slit can allow a solid external device to be placed within the hole. I.e., the slit can allow an external device, where access is prevented on the ends, to be inserted into the hole.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for personalizing items, the system comprising:
a body; and
a hole, wherein the hole passes completely through at least a portion of the body.

2. The system of claim 1, wherein the body includes a shape.

3. The system of claim 2, wherein the shape includes a figure.

4. The system of claim 2, wherein the shape includes a symbol.

5. The system of claim 2, wherein the shape includes writing.

6. The system of claim 2, wherein the shape includes an animal.

7. The system of claim 1, wherein the body includes silicon.

8. The system of claim 1, wherein the body includes one of:
rubber;
pvc;
plastic;
wood;
metal;
gold
platinum; or
silver.

9. The system of claim 1, wherein the body includes one of:
gems;
beads;
jewels;
crystals; or
stones.

10. The system of claim 1, wherein the body includes a colored material.

11. The system of claim 1 further comprising:
a slit, wherein the slit provides access to at least a portion of the hole.

12. A system for personalizing items, the system comprising:
a body;
a hole, wherein the hole passes completely through at least a portion of the body; and
a slit, wherein the slit is configured to allow at least a portion of an external device to be inserted into the hole.

13. The system of claim 12, wherein the external device includes a wire.

14. The system of claim 13, wherein the external device includes a headphone wire.

15. The system of claim 12 further comprising:
an attachment mechanism, wherein the attachment mechanism is configured to attach to an external device.

16. The system of claim 15, wherein the attachment mechanism includes a string

17. The system of claim 15, wherein the attachment mechanism includes a hook and loop fastener.

18. A method of manufacturing a system for personalizing items, the method comprising:
providing a body;
providing a hole, wherein the hole passes completely through at least a portion of the body; and
providing a slit, wherein the slit is configured to allow at least a portion of an external device to be inserted into the hole.

19. The system of claim 18 further comprising:
providing an attachment mechanism, wherein the attachment mechanism is configured to attach to an external device.

20. The system of claim 15, wherein the attachment mechanism includes one of:
includes a string; or
a hook and loop fastener.
